(19) United States
(12) Patent Application Publication
(10) Pub. No.: US 2011/0247976 A1
(43) Pub. Date: Oct. 13, 2011

(54) Method of staggered release or exposure of microorganisms for biological remediation of hydrocarbons and other organic matter

(76) Inventor: Mark D. Shaw, Ponte Vedra Beach, FL (US)

(21) Appl. No.: 12/798,701

(22) Filed: Apr. 9, 2010

(51) Int. Cl. C02F 3/00; C02F 101/32; C02F 101/30

(52) U.S. Cl. 210/601; 210/615

(57) ABSTRACT

A methodology, and related systems and structures for accomplishing the methodology, of biological remediation of hazardous or undesirable organic matter, wherein a plurality of carrier members are disposed in a localized retaining member, the carrier members releasing or exposing microorganisms to the undesirable organic matter on a staggered basis over an extended period of time, the microorganisms being capable of biologically remediating the undesirable organic matter by utilizing the organic matter as a food source, thereby converting it into environmentally safe bi-products.

### BACKGROUND OF THE INVENTION

This invention relates generally to the field of biological remediation, that is, the degradation of hydrocarbons and other organic matter utilizing microorganisms, primarily bacteria, to convert hazardous or undesirable organic matter into environmentally safe byproducts. More particularly, the invention relates to circumstances and applications where it is desirable to provide biological remediation on a long-term basis.

It is well known that microorganisms such as bacteria can be used to remediate undesirable or hazardous matter, waste products, pollution, etc. The microorganisms utilize the undesirable matter as a food source, converting the matter into safe byproducts that can be released into the environment. Such remediation has long been used in septic tank systems, where the microorganisms convert the human waste matter into non-harmful compositions that can be released into the environment. Many other circumstances can be remedied by biological remediation, including oil spills, grease traps, filters and the like, wherein the microorganisms are presented to the undesirable organic matter, such as when absorbent pads containing microorganisms are placed into water at the site of an oil spill, or wherein microorganisms are contained in absorbent filter pads located in a drain.

In many instances it is desirable to have the microorganisms present on an on-going, long-term basis, such as for example in storm water basin filters, where it is impossible to predict when oil or other hydrocarbons may be washed into the storm water system, or in filter drain traps in restaurants, where grease and oils are constantly being flushed into the drain. To address this, it is known to encase or encapsulate the microorganisms such that the coatings or binders dissolve or degrade over time, releasing or exposing the microorganisms in a generally steady manner over an extended period of time, often referred to as time release capsules or the like.

Examples of methodologies of biological remediation and devices incorporating microorganisms for biological remediation are disclosed for example in U.S. Pat. No. 3,242,055 to De Lucia, U.S. Pat. No. 3,860,490 to Guttag, U.S. Pat. No. 4,810,385 to Hater et al., U.S. Pat. No. 5,275,943 to DiTuro, U.S. Pat. No. 5,348,803 to Schlaemus et al., U.S. Pat. No. 5,807,724 to Resnick, U.S. Pat. No. 5,820,762 to Bamer et al., U.S. Pat. No. 5,879,932 to Van Erdewyk, U.S. Pat. No. 6,573,087 to Lehr, U.S. Pat. No. 7,166,221 to Young et al., and U.S. Pat. No. 7,429,221 to Paoluccio et al., the disclosures of which are expressly incorporated herein by reference, in particular to provide enabling examples of formulations for encased or encapsulated microorganisms suitable for biological remediation.

All of the known systems utilize a generally continuous time release mechanism for distributing or exposing the microorganisms to allow for remediation of the hazardous or undesirable hydrocarbons, and this presents a problem in many circumstances. Once released from encapsulation, the colony of microorganisms present in a pad, filter or other carrier member usually has a limited lifespan, such that after a period of time the effectiveness of the biological remediation is diminished or eliminated entirely. This means that periodically the carrier member and its microorganisms must be removed and replaced by a new carrier member with a new colony of microorganisms. The costs to provide replacement carrier members and the labor costs involved in replacing the spent carrier members can be high, especially in circumstances where a large number of sites are involved. For example, in storm water systems wherein hydrocarbon-consuming microorganisms are provided as part of the filtering mechanism in storm drain basins, a given system will have hundreds or even thousands of storm drains. If, instead of the annual maintenance typically required to replace or clean the storm drain filter system, a quarterly or monthly replacement of the microorganism-containing filters must be performed, the increased labor costs are enormous.

It is an object of this invention to provide a methodology and related system and structures for accomplishing the methodology, whereby a plurality of carrier members, such as tablets, capsules or containers, containing microorganisms are retained in situ at locations where biological remediation of hazardous or undesirable organic matter are required over extended periods of time, whereby the carrier members are structured such that the microorganisms within one or a first set of carrier members are released or exposed to begin remediation at one point in time, while the microorganisms within another one or a second set of carrier members are released or exposed to begin remediation at a later time than the first set, and the microorganisms within one or third set of carrier members are released are exposed to begin remediation at a later time than the second set, etc. It is another object to provide such a methodology and related systems and structures whereby the long-term staggered release or exposure of the microorganisms is customizable, such that the staggered release can be periodic, such as monthly or quarterly, or non-periodic in reaction to predictable changing conditions, such as varying seasonal requirements.

### SUMMARY OF THE INVENTION

A methodology, and related systems and structures for accomplishing the methodology, of biological remediation of hazardous or undesirable organic matter, such as hydrocarbons, including oil, grease and fats, human waste, etc., comprises in a broad sense providing a plurality of degradable carrier members in a localized retaining member that will release or expose microorganisms to the undesirable organic matter on a staggered basis (i.e., batch releases rather than continuous time release) over an extended period of time, the microorganisms being capable of biologically remediating the undesirable organic matter by utilizing the organic matter as a food source, thereby converting it into environmentally safe bi-products. The carrier members may be tablets, capsules, pads, mats, filters or any other suitable matrix or structure capable of retaining the microorganisms in a protected manner until it is desired for the microorganisms to remediate the organic matter.

Each carrier member has a predetermined time for initial release or exposure of the microorganisms retained therein, and the method comprises providing within the localized retaining member at least two batches of carrier members having different predetermined initial release or exposure times, such that a first batch of carrier members initially releases or exposes its microorganisms at one time, and the at least second batch of carrier members releases or exposes its microorganisms at a later time, thereby enabling the release or exposure of microorganisms within the retaining member to be staggered over a lengthy time period, such that when the remedial action of the first-released or exposed colony of microorganisms becomes ineffective, the second-released or exposed colony of microorganisms is activated for remediation. The staggering of the initial release or exposure of the batches of microorganisms can be periodic or non-periodic to address predicted circumstances.

The degradable carrier members may be structured in various known manner, such as by encasing the microorganisms within a binder material, encapsulating the microorganisms within a cover or shell, retaining the microorganisms within a container having a degradable sealing member, etc. The microorganisms may also be retained within a container having a mechanical release means, etc. The initial release or exposure time may be controlled by varying the thickness of cover or shell material, choosing different binder or sealing materials that degrade at different rates, etc. The binder, shell or sealing materials may be chosen to degrade over time upon exposure to water, air, sunlight, etc.

### BRIEF DESCRIPTION OF THE DRAWINGS

FIG. 1 is an illustrative view of a representative embodiment of a retaining member in the form of a pad or envelope containing microorganism carrier members of differing sizes.

FIG. 2 is a cross-sectional view of an encased carrier member wherein the microorganisms are mixed with the binder material.

FIG. 3 is a cross-sectional view of an encapsulated carrier member wherein the microorganisms are encapsulated within a binder material.

FIG. 4 is a cross-sectional view of a non-degradable container member having a degradable seal member for release or exposure of the microorganisms.

### DETAILED DESCRIPTION OF THE INVENTION

The invention is general is a methodology, and related systems and structures for accomplishing the methodology, of biological remediation of hazardous or undesirable organic matter, such as hydrocarbons, including oil, grease and fats, human waste, etc., comprising in a broad sense providing a plurality of carrier members in a localized retaining member, the carrier members releasing or exposing microorganisms to the undesirable organic matter on a staggered (i.e., batch releases rather than continuous time release) basis over an extended period of time, the microorganisms being capable of biologically remediating the undesirable organic matter by utilizing the organic matter as a food source, thereby converting it into environmentally safe bi-products.

The carrier members 12 may be tablets, capsules, pads, mats, filters or any other suitable matrix or structure capable of retaining the microorganisms 15 in a protected manner until it is desired for the microorganisms 15 to remediate the organic matter. The carrier members 12 may be structured in various known manner, such as by encasing the microorganisms 15 within a binder material 13, as shown in FIG. 2, encapsulating the microorganisms 15 within a cover or shell binder 14, as shown in FIG. 3, retaining the microorganisms 15 within a non-degradable container 16 having a degradable sealing member 17, as shown in FIG. 4, providing the microorganisms within a container having a mechanical release means, etc. The initial release or exposure time may be controlled by varying the thickness of cover or shell material, choosing different binder or sealing materials that degrade at different rates, etc. The binder, shell or sealing materials may be chosen to degrade over time upon exposure to water, air, sunlight, etc.

For example, microorganisms may be mixed with natural or synthetic binder materials such as a water soluble glue, a hydrophilic acrylate, a cellulose, polyethylene glycol, alginates, caseinares, wax, etc., to form tablets, pellets or the like, whereby the encasing binder material degrades or dissolves over time to release or expose the microorganisms, such that the microorganisms are able to feed on and remediate organic matter. In similar manner, the microorganisms may be encapsulated within shells formed of the same type of materials as listed. There are many known microorganisms that may be utilized, the particular microorganism being chosen based on the organic matter to be remediated and other conditions. Some examples of possible suitable microorganisms include bacterium from the genus Pseudomonas containing plasmids for providing hydrocarbon degradative pathways and bacterium from the genus Vibrio, Micrococcus, Bacillus, Arthrobacter, Nocardia, and Corynebacterium.

Each carrier member 12 has a predetermined time for initial release or exposure of the microorganisms retained therein, and the method comprises providing within the localized retaining member at least two batches of carrier members having different predetermined initial release or exposure times, such that a first batch of carrier members initially releases or exposes its microorganisms at one time, and the at least second batch of carrier members initially releases or exposes its microorganisms at a later time, thereby enabling the release or exposure of microorganisms within the retaining member to be staggered over a lengthy time period, such that when the remedial action of the first-released or exposed colony of microorganisms becomes ineffective, the second-released or exposed colony of microorganisms is activated for remediation. The staggering of the initial release or exposure of differing colonies of microorganisms can be periodic (e.g., every 3 months) or non-periodic (for example March-June-September-March) to address predicted circumstances.

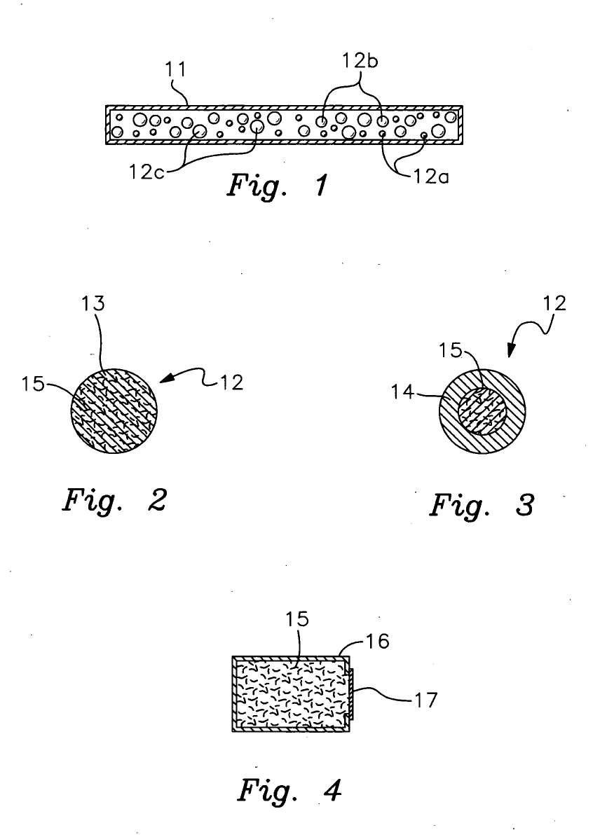

A representative example of a suitable system for practicing the method is shown in FIG. 1, wherein a non-degrading retaining member 11 in the form of a water permeable pad or envelope contains a plurality of carrier members 12a, 12b and 12c consisting of shell members encapsulating microorganisms. The carrier members 12a, 12b, and 12c are shown as having different sizes, signifying that the thickness of the carrier members 12 determines the time period for release or exposure of the microorganisms. The retaining member 11 may for example be inserted into a storm water catch basin filter apparatus such that water passing into the catch basin must pass through or contact the retaining member 11. For example, the initial batch of carrier members 12a may release or expose the microorganisms virtually immediately upon being contacted by water, whereas the second batch of carrier members 12b, being of greater shell thickness, will not release or expose the microorganisms until approximately 3 months after contact with water, and the third batch of carrier members 12c, being of even greater shell thickness, will not release or expose the microorganisms until approximately 6 months after contact with the water. In this manner, when the bioremedial effectiveness of the microorganisms within the batch of carrier members 12a has diminished due to natural decline, exposure to environmental contaminants, etc., a new colony of microorganisms in the batch or carrier members 12b automatically begin remediation action without requiring manual replacement of the retaining member 11, and so on.

It is understood and contemplated that substitutions and equivalents for certain elements set forth above may be obvious to those skilled in the art, and therefore the true scope and definition of the invention is to be as set forth in the following claims.

I claim:

1. A method of biological remediation of hazardous or undesirable organic matter utilizing microorganisms, comprising the steps of:
determining a particular hazardous or undesirable organic matter to be remediated;
selecting a suitable microorganism for remediating said organic matter, said microorganism remediating said organic matter by utilizing said organic matter as a food source;
determining a desired batch release schedule for said microorganisms;
encapsulating a first batch of said microorganisms in a degradable first carrier member, such that said first batch of microorganisms is released upon degradation of said first carrier member after a first time period;
encapsulating a second batch of said microorganisms in a degradable second carrier member, such that said second batch of microorganisms is released upon degradation of said second carrier member after a second time period, said second time period being greater than said first time period; and
positioning said first and second batches at a location wherein said organic matter encounters said released microorganisms.

2. The method of claim 1, further comprising the step of retaining said first and second batches of microorganisms within a nondegradable retaining member.
